(19) United States
(12) Patent Application Publication
(10) Pub. No.: US 2023/0362631 A1
(43) Pub. Date: Nov. 9, 2023

(54) SECURE STORAGE AND PROCESSING OF SIM DATA

(71) Applicant: Apple Inc., Cupertino, CA (US)

(72) Inventors: Deepak DASH, Bangalore (IN); Ahmed M. SOLIMAN, Munich (DE); Nitin KUPPELUR, Bangalore (IN); Ahmed MOUSTAFA, Unterhaching (DE)

(21) Appl. No.: 18/313,813

(22) Filed: May 8, 2023

(30) Foreign Application Priority Data
May 9, 2022 (IN) 202211026763

(51) Int. Cl. H04W 12/033; H04W 12/30; H04W 12/48; H04L 9/06

(52) U.S. Cl. CPC H04W 12/033; H04W 12/35; H04W 12/48; H04L 9/0631

(57) ABSTRACT

This application describes techniques for managing subscriber identity module (SIM) data for a wireless device, including secure storage and processing of SIM data. Select SIM data is encrypted using an encryption key by a processor external to a secure element, e.g., a universal integrated circuit card (UICC) or electronic UICC (eUICC), and at least a portion of the select SIM data is stored in the secure element. The select SIM data can be divided into multiple parts, where a first part of the encrypted SIM data is stored in the secure element, while a second part of the encrypted SIM data is stored external to the secure element, such as in a non-volatile memory (NVM) of the wireless device. The encryption key is stored in a secure NVM of the wireless device. The encrypted SIM data and the encryption key are required to decrypt and recover the SIM data.

### CROSS-REFERENCE TO RELATED APPLICATIONS

The present application claims priority to India Application No. 202211026763, entitled “SECURE STORAGE AND PROCESSING OF SIM DATA,” filed May 9, 2022, the content of which is incorporated by reference herein in its entirety for all purposes.

### FIELD

The described embodiments set forth techniques for management of subscriber identity module (SIM) data for a wireless device, including secure storage and processing of SIM data.

### BACKGROUND

Increasingly, cellular wireless technology is being incorporated into a broad array of electronic devices to provide near-continuous data connectivity and access to various services. At the same time, users are becoming more cognizant of security concerns related to personal data gathered and maintained for the wireless services. Many wireless devices are configured to use removable Universal Integrated Circuit Cards (UICCs) that enable the wireless devices to access services provided by a Mobile Network Operators (MNO). A UICC includes a microprocessor and a memory configured to store an MNO profile that the wireless device can use for registration with an MNO to obtain wireless services provided via a cellular wireless network. A profile may also be referred to as a SIM. Typically, a UICC takes the form of a small removable card, commonly referred to as a SIM card, which is inserted into a UICC-receiving bay of a mobile wireless device. A UICC and/or an eUICC can also store user sensitive data associated with cellular wireless service access. Access to data stored in a readable, unencrypted format on the SIM card can be compromised, e.g., by removal from the wireless device and re-insertion into another wireless device or into a SIM card reader represents a security vulnerability. In more recent implementations, UICCs are being embedded directly into system boards of wireless devices as embedded UICCs (eUICCs), which can provide advantages over traditional, removable UICCs. The eUICCs can include a rewritable memory that can facilitate installation, modification, and/or deletion of one or more electronic SIMs (eSIMs) on the eUICC, where the eSIMs can provide for new and/or different services and/or updates for accessing extended features provided by MNOs. Storage of data on a UICC or eUICC using a personal identification number (PIN) to limit access can provide insufficient protection from adverse parties. In addition, communication between the UICC or eUICC and external processors, such as a baseband wireless processor, can follow a standardized, published communication protocol, which can be monitored directly or indirectly, such as by using deep learning side channel attacks to snoop on user sensitive data. With access to the physical interface of the UICC, such as via a SIM reader device, or by probing the eUICC interface, a malicious third party may gain access to certain user sensitive data. Thus, there exists a need for securing storage and processing of the user sensitive data to reduce the risk of exposing the user sensitive data inadvertently.

### SUMMARY

The described embodiments set forth techniques for management of subscriber identity module (SIM) data for a wireless device, including secure storage and processing of SIM data. Select SIM data is encrypted by a processor external to a secure element, e.g., a universal integrated circuit card (UICC) or electronic UICC (eUICC), and all or a portion of the encrypted SIM data is stored in the secure element. In some embodiments, the encrypted SIM data is divided into at least two parts, and a first part of the encrypted SIM data is stored in the secure element, while a second part of the encrypted SIM data is stored external to the secure element, such as in a non-volatile memory (NVM) of the wireless device. When the encrypted SIM data is divided into multiple parts, both the first and second parts of the encrypted SIM data are required to decrypt and recover the SIM data. Encryption of the SIM data and subsequent decryption is based on cryptographic keys, algorithms, and initialization vectors stored securely in hardware of the wireless device external to the secure element. In some embodiments, a cryptographic key used for encryption of the SIM data is stored in a secure NVM external to the secure element. Representative SIM data to securely encrypt and store include one or more elementary file (EF) values presently stored in an unencrypted format on a UICC/eUICC and communicated outside of the UICC/eUICC, such as during a boot-up process or as part of wireless device registration and/or authentication with a cellular wireless network. Examples of SIM data to secure include a unique subscription identifier, such as an international mobile subscriber identity (IMSI) value, device location information (LOCI), a key set identifier (KSI) value, a non-access stratum (NAS) count value, cryptographic keys, such as a cipher key (CK) and an integrity key (IK). Securing select SIM data, by encrypting and storing the encrypted select SIM data, either as a single part in secure memory of the secure element or divided into multiple parts and stored in separate memories, can improve security of other data that is communicated by the wireless device, such as when the other data is encrypted based on cryptographic keys that are derived from one or more keys that are part of the secured, select SIM data. In some embodiments, a length value of the encrypted SIM data is identical to a length value of the corresponding unencrypted SIM data. In some embodiments when dividing into multiple parts, a first part of the encrypted SIM data has a length value equal to the length value of the corresponding unencrypted SIM data. In some embodiments, the select SIM data is encrypted using an advanced encryption standard (AES) algorithm of 128, 192, or 256 bits. In some embodiments, the unencrypted SIM data is padded with additional bits or bytes to align with the encryption algorithm used. Access to the encrypted SIM data from the secure element alone without access to the cryptographic key required for decryption disallows access to the unencrypted SIM data. Access to a first part of encrypted SIM data stored in the secure element without access to a second part of the encrypted SIM stored external to the secure element (or to the cryptographic key) is insufficient to decrypt and recover the unencrypted SIM data. In some embodiments, the NVM is a secure NVM.

Other aspects and advantages of the present disclosure will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2 illustrates a block diagram of a more detailed view of exemplary components of the system of FIG. 1, according to some embodiments.

FIG. 3 illustrates a block diagram of an architectural overview of wireless device communication, according to some embodiments.

FIGS. 4A, 4B, and 4C illustrate flowcharts of communication procedures with security risks including baseband key derivation dependencies with security risks, according to some embodiments.

FIG. 5 illustrates a diagram of an exemplary encryption of sensitive user data, according to some embodiments.

FIGS. 6A, 6B, 6C and 6D illustrate flowcharts of exemplary methods for securely managing subscriber identity module (SIM) data, according to some embodiments.

FIG. 7 illustrates a block diagram of exemplary elements of a mobile wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The described embodiments set forth techniques for management of subscriber identity module (SIM) data for a wireless device, including secure storage and processing of SIM data. Present techniques to secure sensitive user data with a SIM personal identification number (PIN) is insufficient, as a malicious third party with access to the physical interface of a universal integrated circuit card (UICC) or electronic UICC (eUICC) storing the SIM data can retrieve the SIM data, e.g., using a SIM reader or another wireless device and a brute force search for the SIM PIN value. Side channel attacks via non-invasive deep learning techniques can be used to ascertain user data, as communication between a UICC/eUICC and a processor external to the UICC/eUICC use standards-defined, predictable messages, which can expose the user data inadvertently. With access to certain SIM data, a hacker could use the SIM data to generate cryptographic keys and subsequently decipher additional user signaling and/or payload data communicated via a wireless cellular interface.

To protect user privacy, select SIM data is encrypted by a processor external to a secure element of a wireless device, e.g., a UICC or eUICC that stores the select SIM data, and all or a portion of the encrypted SIM data is stored in the secure element. In some embodiments, the encrypted SIM data is divided into at least two parts, and a first part of the encrypted SIM data is stored in the secure element, while a second part of the encrypted SIM data is stored external to the secure element, such as in a non-volatile memory (NVM) of the wireless device. Encryption of the SIM data can be based on a highly secure encryption algorithm, such as an advanced encryption standard (AES) algorithm that uses at least 128 bits, and preferably 192 bits or 256 bits for encryption. When the encrypted SIM data is divided into multiple parts, both the first and second parts of the encrypted SIM data are required to decrypt and recover the SIM data. Encryption of the SIM data and subsequent decryption is based on cryptographic keys, algorithms, and initialization vectors stored external to the secure element. In some embodiments, a cryptographic key used for encryption and decryption of the SIM data is stored in a secure NVM external to the secure element.

Representative, select SIM data to securely encrypt and store can include one or more elementary file (EF) values presently stored in an unencrypted format on a UICC/eUICC and may be communicated outside of the UICC/eUICC to an external processor of the wireless device that houses the UICC/eUICC, e.g., a baseband processor that communicates with the UICC/eUICC during a boot-up process or as part of wireless device registration and/or authentication with a cellular wireless network. Examples of SIM data to secure include a unique subscription identifier, such as an international mobile subscriber identity (IMSI) value, device location information (LOCI), a key set identifier (KSI) value, a non-access stratum (NAS) count value, cryptographic keys, such as a cipher key (CK) and an integrity key (IK). Securing select SIM data, by encrypting and storing the encrypted SIM data, either as a single part in secure memory of the secure element or divided into multiple parts and stored in separate memories, can improve security of other communication of other data by the wireless device, such as when the other data uses encryption based on cryptographic keys derived from at least a portion of the secured, select SIM data. For example, encryption and/or data integrity keys used generated for communication of cellular wireless data and/or signaling between a wireless device and a cellular wireless network entity can be derived using established procedures at a wireless device based on a portion of the select SIM data. Without access to the select SIM data, the additional keys cannot be derived by a malicious third party. In some embodiments, all or a portion of the encrypted SIM data is stored in the UICC or eUICC in elementary file (EF) locations normally used for unencrypted versions of the SIM data. In some embodiments, a length value of the encrypted SIM data is identical to a length value of the corresponding unencrypted SIM data, such as when storing the encrypted SIM data undivided in the UICC or eUICC. In some embodiments, a first part of the encrypted SIM data has a length value equal to the length value of the corresponding unencrypted SIM data. In some embodiments, the select SIM data is encrypted using an advanced encryption standard (AES) algorithm of 128, 192, or 256 bits. In some embodiments, the unencrypted SIM data is padded with additional bits or bytes as required to align with input requirements of the encryption algorithm used. Access to the encrypted SIM data from the secure element alone without access to the cryptographic key required for decryption disallows access to the unencrypted SIM data. Access to a first part of encrypted SIM data alone, which is stored in the secure element, is insufficient to decrypt and recover the unencrypted SIM data. Access to a first part of encrypted SIM data stored in the secure element without access to a second part of the encrypted SIM stored external to the secure element (or to the cryptographic key) is insufficient to decrypt and recover the unencrypted SIM data. A malicious third party with access the UICC, e.g., by obtaining a SIM card from a wireless device, cannot use data obtained therefrom to retrieve the unencrypted SIM data. In some embodiments, the NVM that stores all or a portion of the encrypted SIM data is a secure NVM.

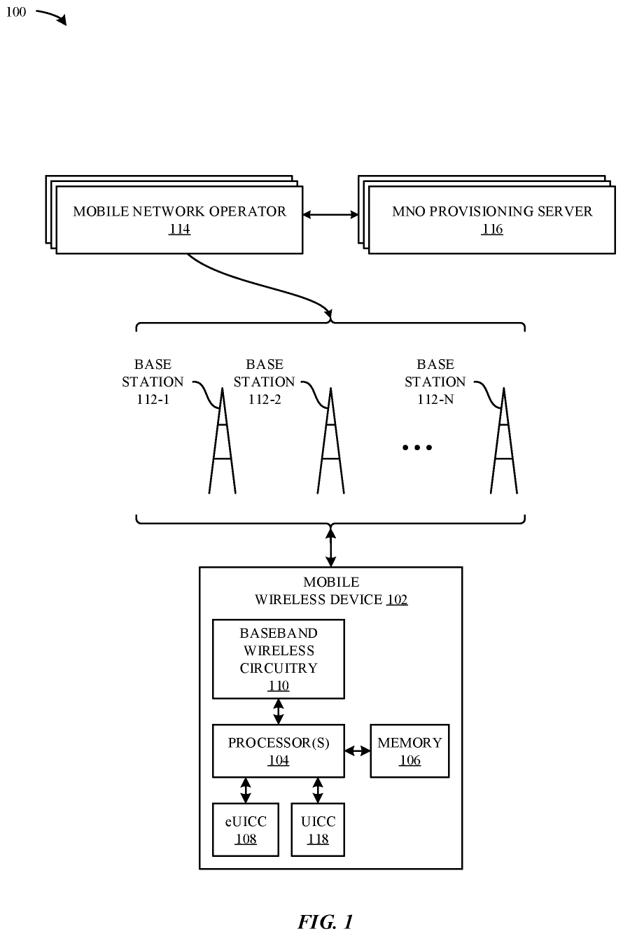

These and other embodiments are discussed below with reference to FIGS. 1-5; however, those skilled in the art will readily appreciate that the detailed description given herein with respect to these figures is for explanatory purposes only and should not be construed as limiting.

FIG. 1 illustrates a block diagram of different components of a system 100 that is configured to implement the various techniques described herein, according to some embodiments. More specifically, FIG. 1 illustrates a high-level overview of the system 100, which, as shown, includes a mobile wireless device 102, which can also be referred to as a wireless device, a wireless device, a mobile device, a user equipment (UE) and the like, a group of base stations 112-1 to 112-N that are managed by different Mobile Network Operators (MNOs) 114, and a set of provisioning servers 116 that are in communication with the MNOs 114. Additional MNO infrastructure servers, such as used for account management and billing are not shown. The mobile wireless device 102 can represent a mobile computing device (e.g., an iPhone® or an iPad® by Apple®) or a cellular-capable wearable device (e.g., an Apple Watch), the base stations 112-1 to 112-n can represent cellular wireless network entities including evolved NodeBs (eNodeBs or eNBs) and/or next generation NodeBs (gNodeBs or gNB) that are configured to communicate with the mobile wireless device 102, and the MNOs 114 can represent different wireless service providers that provide specific cellular wireless services (e.g., voice and data) to which the mobile wireless device 102 can subscribe, such as via a subscription account for a user of the mobile wireless device 102.

As shown in FIG. 1, the mobile wireless device 102 can include processing circuitry, which can include one or more processor(s) 104 and a memory 106, a Universal Integrated Circuit Card (UICC) 118 and/or an embedded UICC (eUICC) 108, and baseband wireless circuitry 110 used for transmission and reception of cellular wireless radio frequency signals. The baseband wireless circuitry 110 can include analog hardware components, such as antennas and amplifiers, as well as digital processing components, such as signal processors (and/or general/limited purpose processors) and associated memory. In some embodiments, the baseband wireless circuitry 110 further includes one or more processors, such as a baseband wireless processor. In some embodiments, the mobile wireless device 102 includes one or more physical UICCs 118, also referred to as Subscriber Identity Module (SIM) cards, in addition to or substituting for the eUICC 108. The components of the mobile wireless device 102 work together to enable the mobile wireless device 102 to provide useful features to a user of the mobile wireless device 102, such as cellular wireless network access, non-cellular wireless network access, localized computing, location-based services, and Internet connectivity. The eUICC 108 can be configured to store multiple electronic SIMs (eSIMs) for accessing cellular wireless services provided by different MNOs 114 by connecting to their respective cellular wireless networks through base stations 112-1 to 112-N. For example, the eUICC 108 can be configured to store and manage one or more eSIMs for one or more MNOs 114 for different subscriptions to which the mobile wireless device 102 is associated.

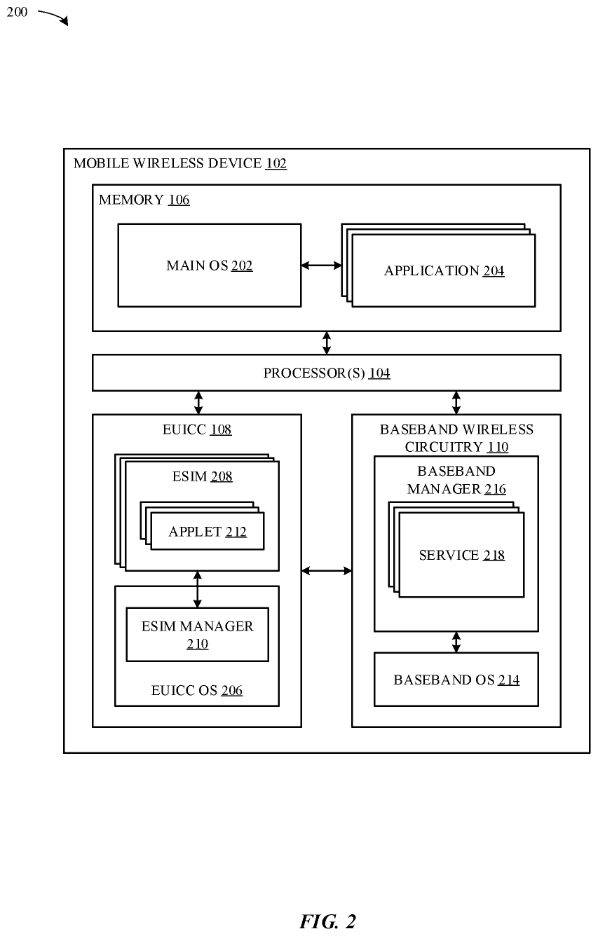

FIG. 2 illustrates a block diagram of a more detailed view 200 of particular components of the mobile wireless device 102 of FIG. 1, according to some embodiments. As shown in FIG. 2, the processor(s) 104, in conjunction with memory 106, can implement a main operating system (OS) 202 that is configured to execute applications 204 (e.g., native OS applications and user applications). As also shown in FIG. 2, the eUICC 108 can be configured to implement an eUICC OS 206 that is configured to manage hardware resources of the eUICC 108 (e.g., a processor and a memory embedded in the eUICC 108). The eUICC OS 206 can also be configured to manage eSIMs 208 that are stored by the eUICC 108, e.g., by downloading, installing, deleting, enabling, disabling, modifying, or otherwise performing management of the eSIMs 208 within the eUICC 108 and providing baseband wireless circuitry 110 with access to the eSIMs 208 to provide access to wireless services for the mobile wireless device 102. The eUICC 108 OS can include an eSIM manager 210, which can perform management functions for various eSIMs 208. According to the illustration shown in FIG. 2, each eSIM 208 can include a number of applets 212 that define the manner in which the eSIM 208 operates. For example, one or more of the applets 212, when implemented in conjunction with baseband wireless circuitry 110 and the eUICC 108, can be configured to enable the mobile wireless device 102 to communicate with an MNO 114 and provide useful features (e.g., phone calls and internet access) to a user of the mobile wireless device 102.

As also shown in FIG. 2, the baseband wireless circuitry 110 of the mobile wireless device 102 can include a baseband OS 214 that is configured to manage hardware resources of the baseband wireless circuitry 110 (e.g., a processor, a memory, different radio components, etc.). According to some embodiments, the baseband wireless circuitry 110 can implement a baseband manager 216 that is configured to interface with the eUICC 108 to establish a secure channel with an MNO provisioning server 116 and obtaining information (such as eSIM data) from the MNO provisioning server 116 for purposes of managing eSIMs 208. The baseband manager 216 can be configured to implement services 218, which represents a collection of software modules that are instantiated by way of the various applets 212 of enabled eSIMs 208 that are included in the eUICC 108. For example, services 218 can be configured to manage different connections between the mobile wireless device 102 and MNOs 114 according to the different eSIMs 208 that are enabled within the eUICC 108.

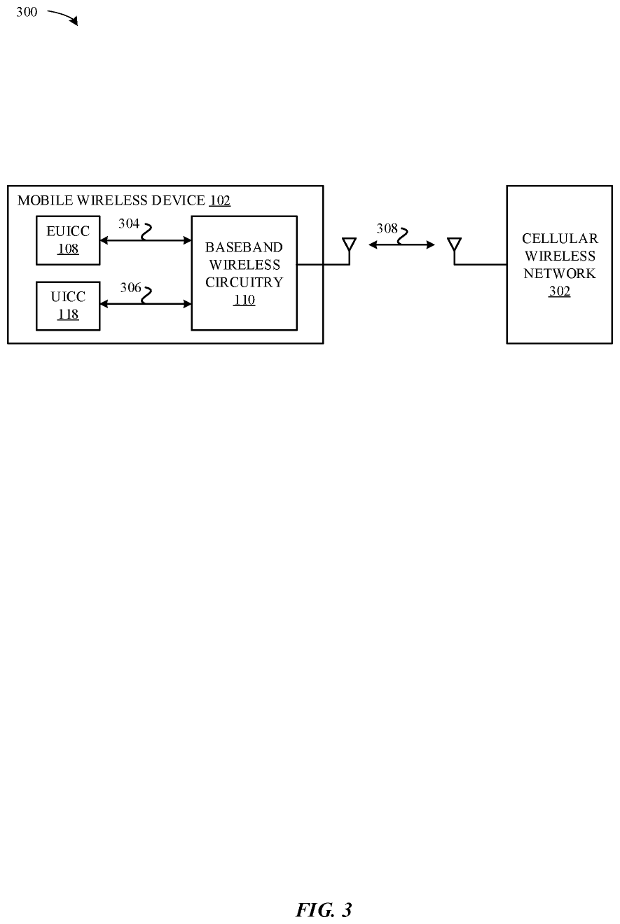

FIG. 3 illustrates a block diagram 300 providing an architectural overview of communication by a mobile wireless device 102 with a cellular wireless network 302. The mobile wireless device 102 includes baseband wireless circuitry 110, which can include a baseband processor that generates and consumes digital signals transmitted and received by one or more antennas through an encrypted radio air interface 308 with network entities of a cellular wireless network 302. Security of the encrypted radio air interface 308 is based on parameters that are derived at least in part on information communicated via standardized interfaces 304, 306 with an eUICC 108 or a UICC 118 respectively. Vulnerability of the standardized interfaces 304, 306 to malicious snooping to obtain SIM/eSIM information may result in exposing encrypted over-the-air (OTA) signaling and/or user data messages being at risk of decryption by a third-party. One or more processors, e.g., a baseband processor, of the mobile wireless device 102 accesses one or more elementary files (EFs) stored on the eUICC 108 and/or the UICC 118 during various processes, e.g., during a boot-up process and/or during an authentication and key agreement (AKA) process. Representative EFs that can be read, and information provided by the eUICC 108 and/or the UICC 118 without encryption (via standardized protocols) include international mobile subscriber identity (IMSI) values, location information (LOCI) values, security context information, such as non-access stratum (NAS) count values, and encryption parameters, such as a key set indicator (KSI) value, a cipher key (CK), and integrity key (IK). With access to the NAS count value, CK value, and IK value, a third party could decipher signaling and/or user data messages communicated in an encrypted (and presumed secure) format over the radio air interface 308. As described further herein, sensitive user data, for privacy purposes and/or for security reasons, are encrypted and only a first portion of the encrypted versions are stored in the eUICC 108 and/or the UICC 118 for later access. Without access to the second portion of the encrypted versions and without access to encryption keys securely stored in a non-volatile memory of the mobile wireless device 102, the sensitive user data cannot be accessed by a malicious third party actor.

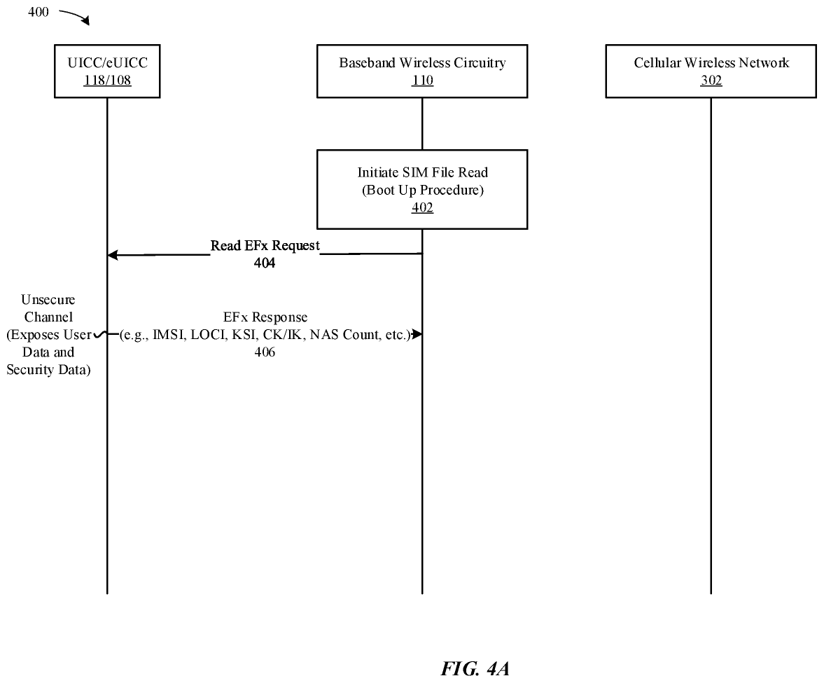

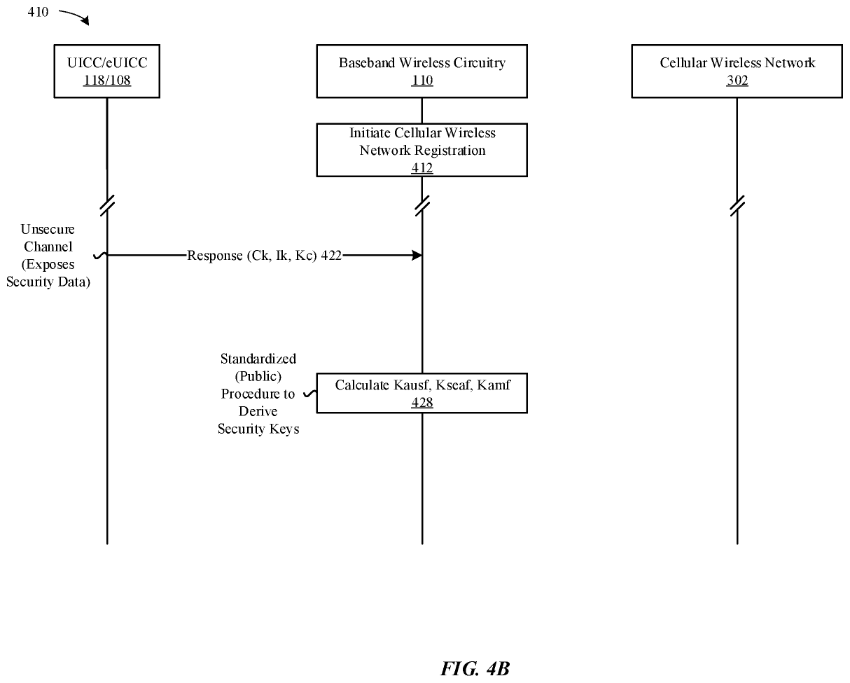

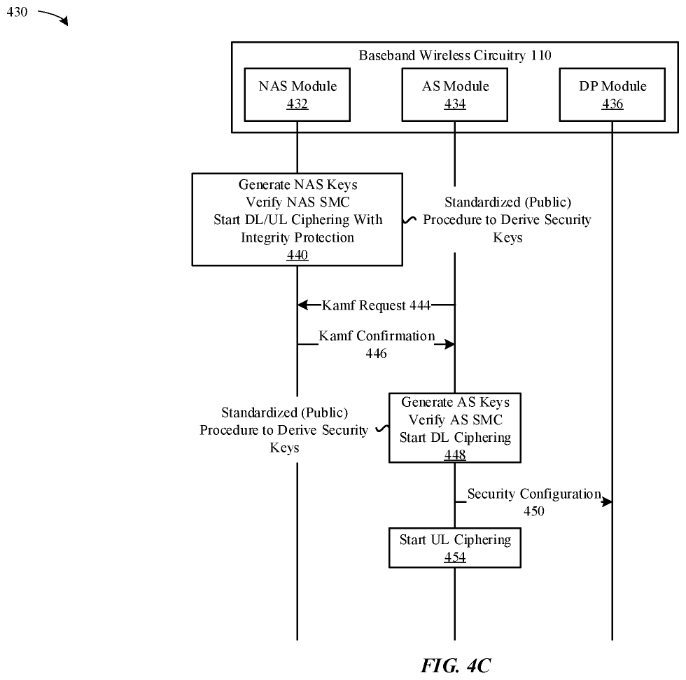

FIG. 4A illustrates a flowchart 400 of an exemplary communication procedure with a security risk performed by a mobile wireless device 102. At 402, during a boot-up procedure, baseband wireless circuitry 110, which can include a baseband processor, can initiate reading of one or more elementary files (EFs) from a SIM stored in a UICC 118 or from an eSIM 208 stored in an eUICC 108. At 404, one or more read request messages to read a designated EF of a SIM or eSIM 208 is sent from the baseband wireless circuitry 110 to the UICC/eUICC 118/108. At 406, the UICC/eUICC 118/108 returns a response message that includes the requested EF value of the SIM or eSIM 208 to the baseband wireless circuitry 110. Example EF responses include an IMSI value, LOCI value, key set indicator (KSI) value, a CK value, an IK value, a NAS count, etc. Communication between the UICC/eUICC 118/108 is not encrypted, per presently used standardized communication protocols, and therefore the communication channel between the UICC/eUICC 118/108 and the baseband wireless circuitry 110 can expose sensitive user data or other security parameters.

FIG. 4B illustrates a flowchart 410 of another exemplary communication procedure with a security risk performed by a mobile wireless device 102. At 412, the baseband wireless circuitry 110 of the mobile wireless device 102 initiates a procedure for registration with a cellular wireless network 302. After a number of intervening actions (not shown), as part of enabling security with the cellular wireless network 302, the UICC/eUICC 118/108 can provide to the baseband wireless circuitry 110 a cipher key (Ck) value, an integrity key (Ik) value, and in some cases a ciphering key (Kc). At 422, the UICC/eUICC 118/108 sends a response message that includes the generated parameters Ck, Ik, Kc to the baseband wireless circuitry 110. As the communication channel between the UICC/eUICC 118/108 is not secured (e.g., not encrypted), communication of the parameters can expose security data, such as the cryptographic keys Ck and Ik. At 428, the baseband wireless circuitry 110 can calculate additional security keys, such as the authentication server function key Kausf, the security anchor function key Kseaf, and the access and mobility management function key Kamf using the previously received cryptographic keys Ck and Ik. With knowledge of the cryptographic keys Ck and Ik, a malicious third party could use standardized (publicly known) procedures to derive the additional security keys Kausf, Kseaf, and Kamf. Each of these security keys is crucial to realize secure, encrypted signaling and data communication between the mobile wireless device 102 and the cellular wireless network 302.

FIG. 4C illustrates a flowchart 430 of a further exemplary communication procedure with a security risk performed by a mobile wireless device 102. The procedure illustrated in FIG. 4C includes generation of additional security keys for NAS and AS encrypted communication. These additional security keys can be based on the cryptographic keys Ck and Ik illustrated in FIG. 4B, and as such if the cryptographic keys Ck and Ik are compromised, the additional NAS and AS security keys are also at risk of being derived and used by a malicious third party. At 440, the NAS module 432 generates a set of NAS cryptographic keys and initiates use of downlink (DL) and uplink (UL) ciphering with integrity protection for NAS messaging. The procedure to generate the NAS cryptographic keys is standardized (publicly known) and is vulnerable should the inputs used to generate the NAS cryptographic keys be intercepted and used by another party. At 444, an access stratum (AS) module sends a request message with the cryptographic key Kamf, and the NAS module 432 replies with a confirmation message at 446. At 448, the AS module generates AS cryptographic keys and initiates DL ciphering for AS messaging. As with the NAS cryptographic key generation, the AS cryptographic keys are generated using standardized (publicly known) procedures and vulnerable should the inputs required for their generation be intercepted and used by a third party. At 450, the AS module 434 sends a security request message to a DP module 436. At 454, the AS module initiates ciphering for UL AS messages. If the NAS keys and/or the AS keys are compromised, then NAS and/or AS communication, e.g., signaling and/or data messages, can be intercepted and deciphered. Thus, as discussed herein, sensitive user data, including cryptographic keys can be protected by encrypting the sensitive user data, dividing the encrypted sensitive user data into multiple parts, and storing the separate parts of the encrypted user sensitive data in separate memories of separate components of the mobile wireless device 102.

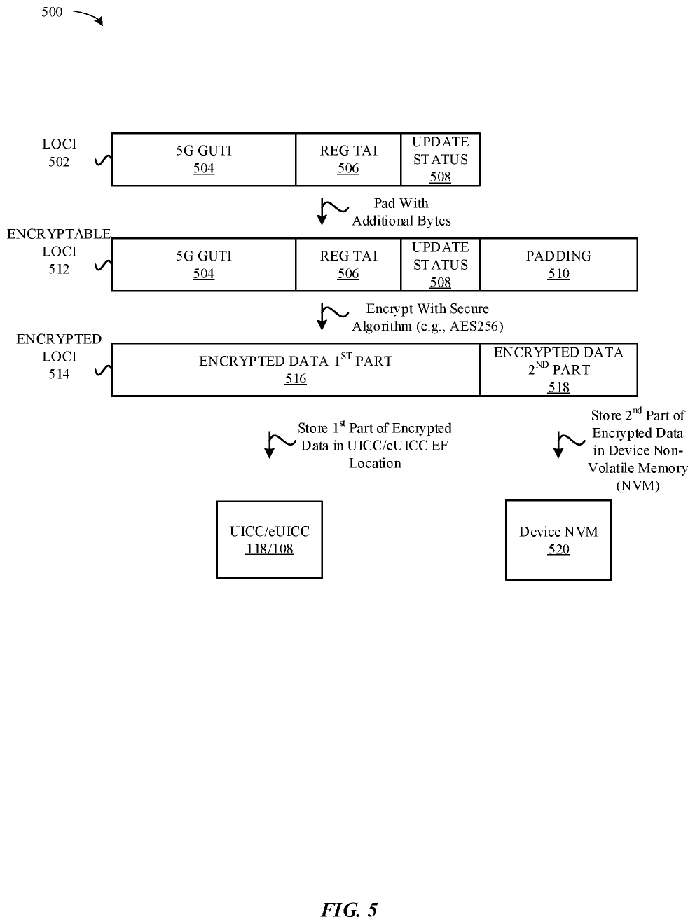

FIG. 5 illustrates a diagram 500 of an exemplary encryption of sensitive user data. As discussed herein, during one or more procedures, communication of unencrypted sensitive user data between a UICC/eUICC 118/108 and baseband wireless circuitry 110 of a mobile wireless device 102 is vulnerable to snooping an misuse by a malicious third-party. To protect the user sensitive data, a secure encryption algorithm can be applied to select sensitive user data to generate encrypted sensitive user data. The encrypted sensitive user data can be stored at least in part in the UICC/eUICC 118/108. In some embodiments, the encrypted sensitive user data is divided into multiple parts and only a first part of the encrypted sensitive user data is stored in the UICC/eUICC 118/108, while a second part of the encrypted sensitive user data is stored in a non-volatile memory (NVM) of the wireless device external to the UICC/eUICC 118/108. Without access to a second part of the encrypted sensitive user data or to a symmetric encryption key used to encrypt the sensitive user data, where the symmetric encryption key is stored outside the UICC/eUICC 118/108 in a secure NVM of the wireless device, the unencrypted versions of the sensitive user data cannot be recovered. A user's location information (LOCI) value 502, which is communicated by a cellular wireless network 302 to a mobile wireless device 102 can be protected by encryption. The LOCI value 502, as used in a 5G cellular wireless network, can include a 5G globally unique temporary identifier (GUTI) value 504, which is assigned by the 5G cellular wireless network to the mobile wireless device 102 during registration. The LOCI value 502 also includes registration tracking area identifier (TAI) value 506 and an update status 508. The LOCI value 502 can be padded with additional bits or bytes, e.g., padding 510, to form an encryptable LOCI value 512 having a length applicable to an encryption algorithm to be used. For example, an advanced encryption standard (AES) 256 algorithm can require a 128 bit (16 byte) long input with a 256-bit encryption key and a 128 bit initialization vector. The mobile wireless device 102 can encrypt the encryptable LOCI value 512 using the encryption algorithm, e.g., the AES 256 algorithm, to produce an identically sized 128 bit (16 byte) long output, referred to as the encrypted LOCI value 514. The encryption can use a symmetric key that is stored in a secure NVM of the mobile wireless device 102, such as during manufacture of the mobile wireless device 102. The mobile wireless device 102 can divide the encrypted LOCI value 514 into at least two distinct parts, e.g., an encrypted data first part 516 and an encrypted data second part 518. The mobile wireless device 102 can store the first part 516 of encrypted sensitive user data in an applicable EF location of a SIM in a UICC 118 or an eSIM 208 in an eUICC 108. The length of the first part 516 of encrypted sensitive user data can be identical to the length of the unencrypted sensitive user data, e.g., the first part 516 of encrypted LOCI 514 has the same length as the unencrypted LOCI value 502. The mobile wireless device 102 stores the second part 518 of encrypted sensitive user data in a non-volatile memory (NVM) 520 of the mobile wireless device 102. Both the first part 516 of encrypted data and the second part 518 of encrypted data can be required to decrypt and retrieve the unencrypted user sensitive data. In some embodiments, the encryption key of the encryption algorithm, e.g., the 256-bit encryption key of the AES 256 algorithm, is stored in a secure memory of the mobile wireless device 102 at a time of manufacture. In some embodiments, access to the encryption key and the initialization vector stored in the NVM 520 for the encryption algorithm is restricted to a particular hardware module of the mobile wireless device 102. The exemplary encryption shown in FIG. 5 for the LOCI value 502 can be also used to encrypt other user sensitive data, such as an IMSI value, one or more cryptographic keys, a key set identifier, one or more integrity keys, and the like. The encryption key and a portion of the encrypted sensitive user data are stored in secure memory of the mobile wireless device 102 and therefore not accessible with access to communication of the UICC 118 or eUICC 108 alone. Retrieval of the second part of encrypted sensitive user data from the NVM and access to the encryption parameters can be internal to a processor of the mobile wireless device 102 and therefore protected from side channel attacks. Access to the first part of encrypted sensitive user data from the UICC 118 or eUICC 108 is insufficient to recover the unencrypted sensitive user data. Transfer of a UICC 118 to another mobile wireless device 102, or transfer of contents of an eUICC 108 to another eUICC 108 of another mobile wireless device 102 will not allow sensitive user data to be accessed, as a portion of the encrypted sensitive user data and the encryption parameters required for decryption remain in the original mobile wireless device 102.

In some embodiments, the encrypted sensitive user data has a length value equal to the unencrypted sensitive user data, and the encrypted sensitive user data is stored in place of the unencrypted sensitive user data in the UICC 118 or eUICC 108. Access to the UICC 118 or eUICC 108 by a malicious third party to obtain the encrypted sensitive user data is insufficient to decrypt and recover the unencrypted sensitive user data, as the symmetric encryption key is stored securely in a secure NVM of the mobile wireless device 102 separately from the UICC 118 or eUICC 108.

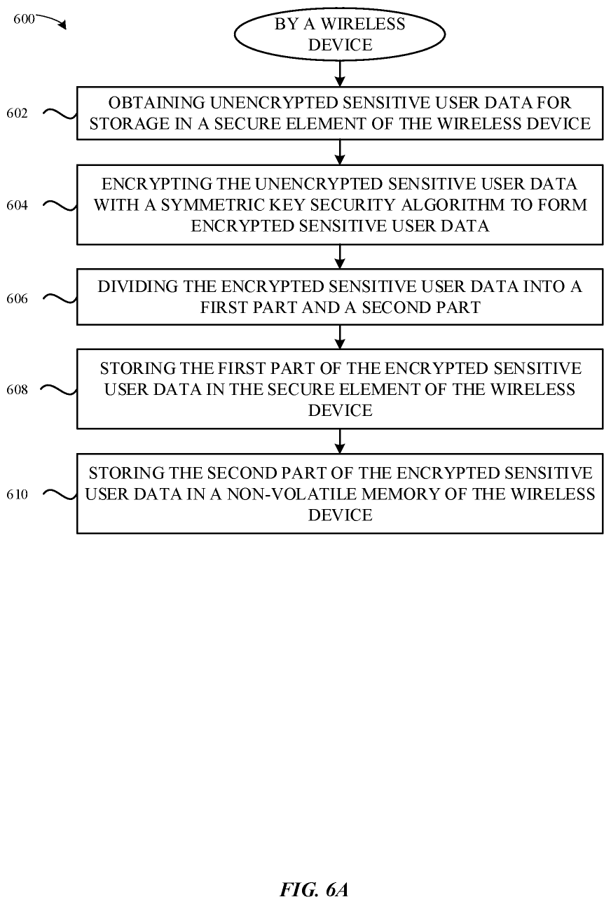

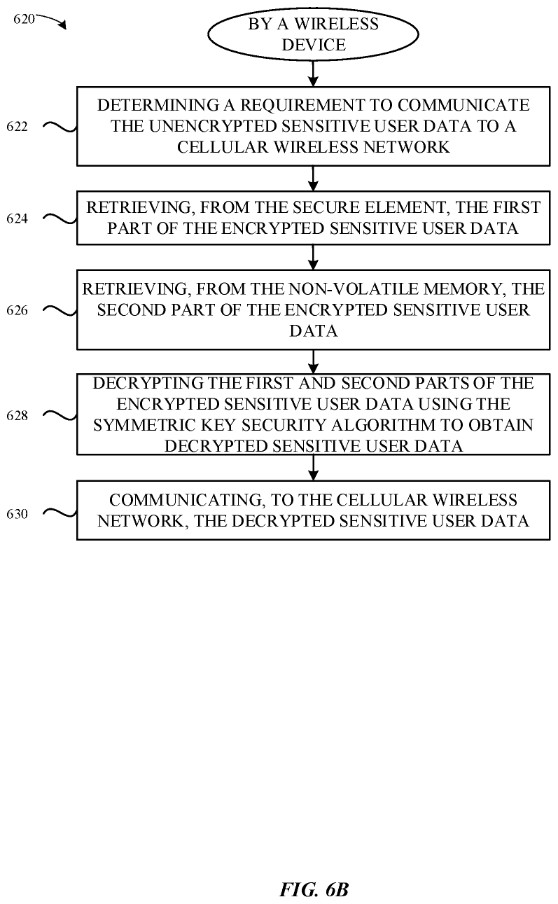

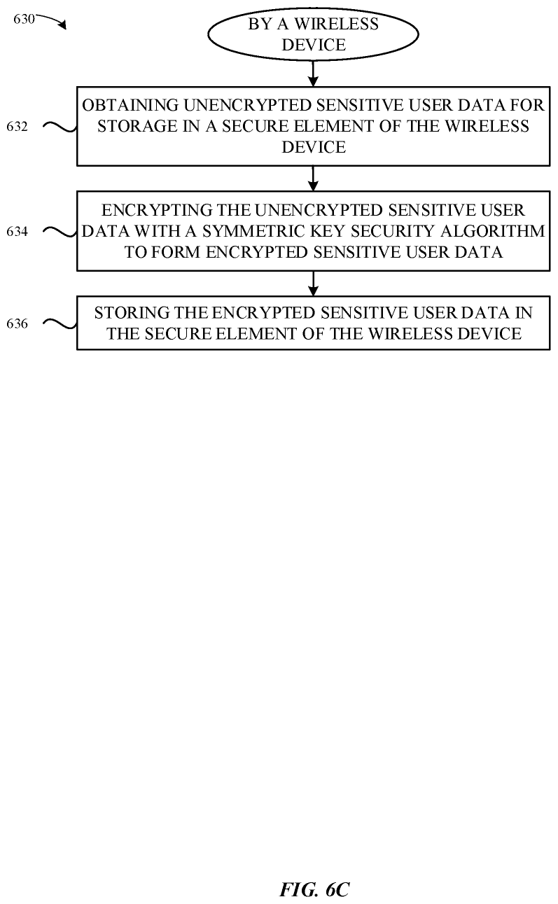

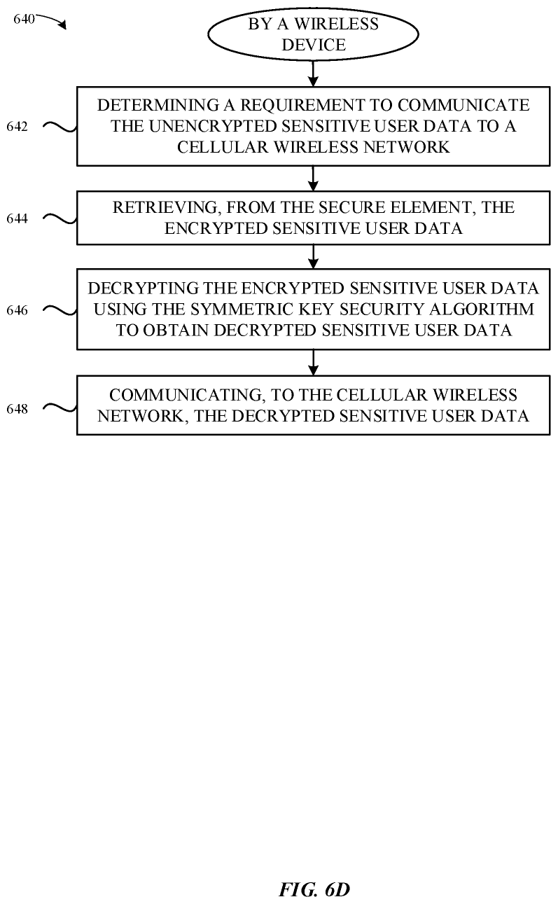

FIG. 6A illustrates a flowchart 600 of an exemplary method to secure sensitive user data on a wireless device 102. At 602, the wireless device 102 obtains unencrypted sensitive user data intended for storage in a secure element (SE) of the wireless device 102. At 604, the wireless device 102 encrypts the unencrypted sensitive user data with a symmetric key security algorithm to form encrypted sensitive user data. At 606, the wireless device 102 divides the encrypted sensitive user data into a first part and a second part. At 608, the wireless device 102 stores the first port of the encrypted sensitive user data in the SE of the wireless device 102. At 610, the wireless device 102 stores the second part of the encrypted sensitive user data in a non-volatile memory (NVM) of the wireless device 102.

FIG. 6B illustrates a flowchart 620 of an exemplary method to manage sensitive user data by a wireless device 102. At 622, the wireless device 102 determines a requirement to communicate the unencrypted sensitive user data to a cellular wireless network. At 624, the wireless device 102 retrieves, from the SE of the wireless device 102, the first part of the encrypted sensitive user data. At 626, the wireless device 102 retrieves, from the NVM, the second part of the encrypted sensitive user data. At 628, the wireless device 102 decrypts the first and second parts of the encrypted sensitive user data using the symmetric key security algorithm to obtain decrypted sensitive user data. At 630, the wireless device 102 communicates the decrypted sensitive user data to the cellular wireless network.

In some embodiments, the unencrypted sensitive user data includes a value for an elementary file (EF) associated with a SIM stored on a UICC 118 or an eSIM 208 stored on an eUICC 108. In some embodiments, a length of the first part of the encrypted sensitive user data equals a length of the unencrypted sensitive user data. In some embodiments, the wireless device 102 pads the unencrypted sensitive user data to an encryption length associated with the symmetric key security algorithm. In some embodiments, the symmetric key security algorithm includes an advanced encryption standard (AES) algorithm using a 128-bit initialization vector and a 256-bit symmetric key. In some embodiments, a symmetric key of the symmetric key security algorithm is stored in a secure NVM of the wireless device 102 at a time of manufacture. In some embodiments, the unencrypted sensitive user data includes a location information (LOCI) value obtained from a cellular wireless network. In some embodiments, the unencrypted sensitive user data includes a non-access stratum (NAS) count value maintained by the wireless device 102. In some embodiments, encryption of the unencrypted sensitive user data is performed by baseband wireless circuitry 110 of the wireless device 102. In some embodiments, communication between the baseband wireless circuitry 110 and the secure element of the wireless device is in accordance with a third generation partnership project (3GPP) standardized protocol.

FIG. 6C illustrates a flowchart 630 of another exemplary method to secure sensitive user data on a wireless device 102. At 632, the wireless device 102 obtains unencrypted sensitive user data intended for storage in a secure element (SE) of the wireless device 102. At 634, the wireless device 102 encrypts the unencrypted sensitive user data with a symmetric key security algorithm to form encrypted sensitive user data. At 636, the wireless device 102 stores the encrypted sensitive user data in the SE of the wireless device 102.

FIG. 6D illustrates a flowchart 640 of another exemplary method to manage sensitive user data by a wireless device 102. At 642, the wireless device 102 determines a requirement to communicate the unencrypted sensitive user data to a cellular wireless network. At 644, the wireless device 102 retrieves, from the SE of the wireless device 102, the encrypted sensitive user data. At 646, the wireless device 102 decrypts the encrypted sensitive user data using the symmetric key security algorithm to obtain decrypted sensitive user data. At 648, the wireless device 102 communicates the decrypted sensitive user data to the cellular wireless network.

In some embodiments, the unencrypted sensitive user data includes a value for an elementary file (EF) associated with a SIM stored on a UICC 118 or an eSIM 208 stored on an eUICC 108 of the wireless device 102. In some embodiments, a length of the encrypted sensitive user data equals a length of the unencrypted sensitive user data.

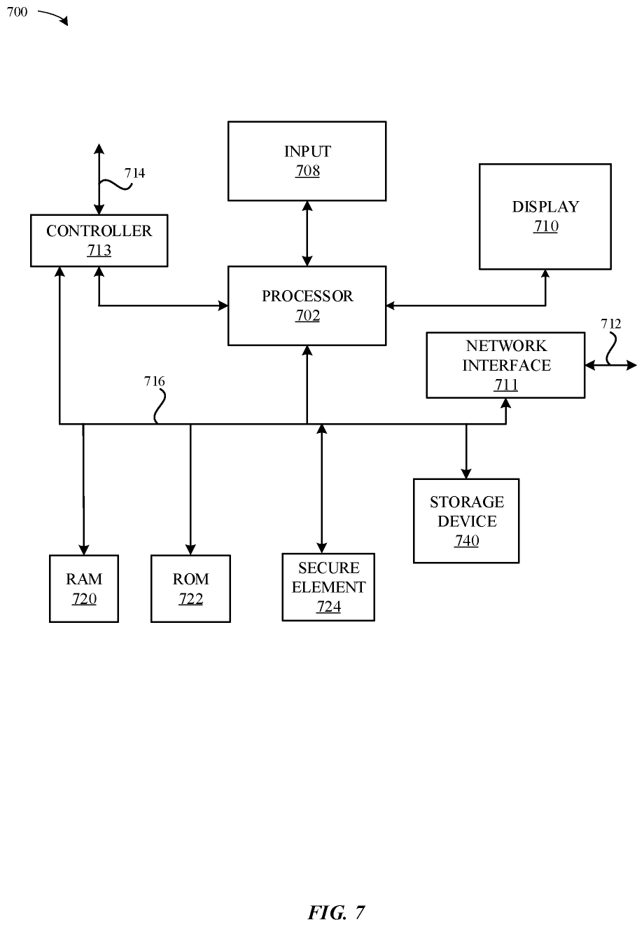

FIG. 7 illustrates a detailed view of a representative computing device 700 that can be used to implement various methods described herein, according to some embodiments. In particular, the detailed view illustrates various components that can be included in the mobile wireless device 102. As shown in FIG. 7, the computing device 700 can include a processor 702 that represents a microprocessor or controller for controlling the overall operation of computing device 700. The computing device 700 can also include a user input device 708 that allows a user of the computing device 700 to interact with the computing device 700. For example, the user input device 708 can take a variety of forms, such as a button, keypad, dial, touch screen, audio input interface, visual/image capture input interface, input in the form of sensor data, etc. Still further, the computing device 700 can include a display 710 that can be controlled by the processor 702 to display information to the user. A data bus 716 can facilitate data transfer between at least a storage device 740, the processor 702, and a controller 713. The controller 713 can be used to interface with and control different equipment through an equipment control bus 714. The computing device 700 can also include a network/bus interface 711 that communicatively couples to a data link 712. In the case of a wireless connection, the network/bus interface 711 can include a wireless transceiver.

The computing device 700 also includes a storage device 740, which can comprise a single disk or a plurality of disks (e.g., hard drives), and includes a storage management module that manages one or more partitions within the storage device 740. In some embodiments, storage device 740 can include flash memory, semiconductor (solid state) memory or the like. The computing device 700 can also include a Random Access Memory (RAM) 720 and a Read-Only Memory (ROM) 722. The ROM 722 can store programs, utilities or processes to be executed in a non-volatile manner. The RAM 720 can provide volatile data storage, and stores instructions related to the operation of the computing device 700. The computing device 700 further includes a secure element 724, which can include an eUICC 108 on which to store one or more eSIMs 208 and/or a UICC 118 (physical SIM card) on which to store one or more SIM profiles.

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for securing subscriber identity module (SIM) data on a wireless device, the method comprising:
by the wireless device:
obtaining unencrypted sensitive user data for storage in a secure element of the wireless device;
encrypting the unencrypted sensitive user data with a symmetric key security algorithm to form encrypted sensitive user data;
dividing the encrypted sensitive user data into a first part and a second part;
storing the first part of the encrypted sensitive user data in the secure element of the wireless device; and
storing the second part of the encrypted sensitive user data in a non-volatile memory (NVM) of the wireless device.

2. The method of claim 1, further comprising:
by the wireless device:
determining a requirement to communicate the unencrypted sensitive user data to a cellular wireless network;
retrieving, from the secure element, the first part of the encrypted sensitive user data;
retrieving, from the NVM, the second part of the encrypted sensitive user data;
decrypting the first and second parts of the encrypted sensitive user data using the symmetric key security algorithm to obtain decrypted sensitive user data; and
communicating, to the cellular wireless network, the decrypted sensitive user data.

3. The method of claim 1, wherein the unencrypted sensitive user data comprises a value for an elementary file (EF) associated with a SIM stored on a universal integrated circuit card (UICC) or an electronic SIM (eSIM) stored on an embedded UICC (eUICC).

4. The method of claim 1, wherein a length of the first part of the encrypted sensitive user data equals a length of the unencrypted sensitive user data.

5. The method of claim 1, further comprising:
padding, by the wireless device, the unencrypted sensitive user data to an encryption length associated with the symmetric key security algorithm.

6. The method of claim 1, wherein the symmetric key security algorithm comprises an advanced encryption standard (AES) algorithm using a 128-bit initialization vector and a 256-bit symmetric key.

7. The method of claim 1, wherein a symmetric key of the symmetric key security algorithm is stored in a secure NVM of the wireless device at a time of manufacture.

8. The method of claim 1, wherein the unencrypted sensitive user data comprises a location information (LOCI) value obtained from a cellular wireless network.

9. The method of claim 1, wherein the unencrypted sensitive user data comprises a non-access stratum (NAS) count value maintained by the wireless device.

10. A wireless device comprising:
wireless circuitry including one or more antennas; and
processing circuitry communicatively coupled to the wireless circuitry, the processing circuitry comprising a baseband wireless processor, a universal integrated circuit card (UICC) or an embedded UICC (eUICC) storing at least one subscriber identity module (SIM) or electronic SIM (eSIM), and at least one storage element storing instructions that when executed by the processing circuitry cause the wireless device to:
obtain unencrypted sensitive user data for storage in the UICC or eUICC of the wireless device;
encrypt the unencrypted sensitive user data with a symmetric key security algorithm to form encrypted sensitive user data;
divide the encrypted sensitive user data into a first part and a second part;
store the first part of the encrypted sensitive user data in the UICC or eUICC of the wireless device; and
store the second part of the encrypted sensitive user data in a non-volatile memory (NVM) of the wireless device.

11. The wireless device of claim 10, wherein the wireless device is further configured to:
determine a requirement to communicate the unencrypted sensitive user data to a cellular wireless network;
retrieve, from the UICC or the eUICC, the first part of the encrypted sensitive user data;
retrieve, from the NVM, the second part of the encrypted sensitive user data;
decrypt the first and second parts of the encrypted sensitive user data using the symmetric key security algorithm to obtain decrypted sensitive user data; and
communicate, to the cellular wireless network, the decrypted sensitive user data.

12. The wireless device of claim 10, wherein the unencrypted sensitive user data comprises a value for an elementary file (EF) associated with the at least one SIM or eSIM stored respectively on the UICC or the eUICC of the wireless device.

13. The wireless device of claim 10, wherein a length of the first part of the encrypted sensitive user data equals a length of the unencrypted sensitive user data.

14. The wireless device of claim 10, wherein the wireless device is further configured to:
pad the unencrypted sensitive user data to an encryption length associated with the symmetric key security algorithm.

15. The wireless device of claim 10, wherein the symmetric key security algorithm comprises an advanced encryption standard (AES) algorithm using a 128-bit initialization vector and a 256-bit symmetric key.

16. The wireless device of claim 10, wherein a symmetric key of the symmetric key security algorithm is stored in a secure NVM of the wireless device at a time of manufacture.

17. The wireless device of claim 10, wherein the unencrypted sensitive user data comprises a location information (LOCI) value obtained from a cellular wireless network.

18. The wireless device of claim 10, wherein the unencrypted sensitive user data comprises a non-access stratum (NAS) count value maintained by the wireless device.

19. A method for securing subscriber identity module (SIM) data on a wireless device, the method comprising:
by the wireless device:
obtaining unencrypted sensitive user data for storage in a secure element of the wireless device;
encrypting the unencrypted sensitive user data with a symmetric key security algorithm to form encrypted sensitive user data; and
storing the encrypted sensitive user data in a secure memory of the secure element of the wireless device.

20. The method of claim 19, further comprising:
by the wireless device:
determining a requirement to communicate the unencrypted sensitive user data to a cellular wireless network;
retrieving, from the secure memory of the secure element, the encrypted sensitive user data;
decrypting the encrypted sensitive user data using the symmetric key security algorithm to obtain decrypted sensitive user data; and
communicating, to the cellular wireless network, the decrypted sensitive user data.
